(19) United States
(12) Patent Application Publication
(10) Pub. No.: US 2024/0349804 A1
(43) Pub. Date: Oct. 24, 2024

(54) AEROSOL GENERATING DEVICE AND AEROSOL GENERATING METHOD FOR OPTIMIZING FREQUENCY OF CURRENT FLOWING THROUGH COIL

(71) Applicant: KT&G CORPORATION, Daejeon (KR)

(72) Inventors: Yong Hwan KIM, Anyang-si, Gyeonggi-do (KR); Sung Wook YOON, Suwon-si, Gyeonggi-do (KR); Seung Won LEE, Gwangmyeong-si, Gyeonggi-do (KR); Seok Su JANG, Daejeon (KR); Dae Nam HAN, Seoul (KR)

(73) Assignee: KT&G CORPORATION, Daejeon (KR)

(21) Appl. No.: 17/917,841

(22) PCT Filed: Jul. 26, 2021
(86) PCT No.: PCT/KR2021/009615

§ 371 Date: Oct. 7, 2022

(30) Foreign Application Priority Data
Jul. 27, 2020 (KR) 10-2020-0093175

(51) Int. Cl. A24F 40/465; A24F 40/20; A24F 40/53

(52) U.S. Cl. CPC A24F 40/465; A24F 40/53; A24F 40/20

(57) ABSTRACT

An aerosol generating device includes: a coil configured to generate a magnetic field by a current flowing through the coil; a heater configured to be induction heated via the magnetic field; and a controller configured to control the current. The controller is further configured to change a frequency of the current flowing through the coil within a pre-set driving frequency range; and determine whether a magnitude of the current flowing through the coil exceeds a threshold value according to one or more changed frequencies of the current.

### TECHNICAL FIELD

Embodiments of the present disclosure relate to an aerosol generating device and an aerosol generating method for optimizing a frequency of a current flowing through a coil, and more particularly, to an aerosol generating device and an aerosol generating method, wherein the aerosol generating device includes a coil for heating a heater by an induction heating method, and the aerosol generating device and the aerosol generating method are capable of optimizing a frequency of a current flowing through the coil.

### BACKGROUND ART

Recently, there has been increasing demand for alternative ways of overcoming the disadvantages of common cigarettes. For example, there is an increasing demand for a method of generating aerosol by heating an aerosol generating material in cigarettes, rather than by burning cigarettes. Accordingly, research into a heating-type cigarette or a heating-type aerosol generator has been actively conducted.

A heater of the aerosol generating device may be realized as various types. One of the types corresponds to a heater realized by using a coil and a susceptor. In detail, the heater using the coil and the susceptor is realized based on a principle that, when an alternating current is allowed to flow through a coil having a unique inductance, an alternating magnetic field is generated to induce an eddy current in a nearby susceptor so that the susceptor is heated by the induced eddy current.

### DISCLOSURE

### Technical Problem

When a frequency of the current flowing through the coil is optimized, a magnitude of the current flowing through the coil increases, and thus, heating efficiency of the susceptor (the heater) is greatly increased. However, since an aerosol generating device includes various pieces of hardware that electrically affect one another, a method of efficiently searching for an optimum frequency is required.

### Technical Solution

A technical objective to be achieved by embodiments of the present disclosure is to provide an aerosol generating device and an aerosol generating method that are capable of finding an optimum frequency of a current flowing through a coil, the coil being included in the aerosol generating device implementing a heater applying an induction heating method.

A device according to an embodiment of the present disclosure for solving the technical problem described above includes: a coil, through which a current flows; a heater which is induction heated via a magnetic field generated by the current; and a controller configured to control the current, wherein the controller is further configured to: change a frequency of the current flowing through the coil within a pre-set driving frequency range; and determine whether a magnitude of the current flowing through the coil exceeds a threshold value according to one or more changed frequencies.

A method according to another embodiment of the present disclosure for solving the technical problem described above includes: monitoring a magnitude of a current flowing through a coil, by changing a frequency within a pre-set driving frequency range; identifying a frequency at which the magnitude of the current of the coil has a greatest value; and determining whether the magnitude of the current at the identified frequency exceeds a threshold value.

A method according to another embodiment of the present disclosure for solving the technical problem described above includes: monitoring a magnitude of a current flowing through a coil, by changing a frequency within a pre-set first frequency range; identifying a first frequency at which the magnitude of the current of the coil has a greatest value; when the magnitude of the current at the identified frequency is less than a threshold value, setting a second frequency range; identifying a second frequency at which the magnitude of the current flowing through the coil has a greatest value, by changing the frequency within the second frequency range; and, when the magnitude of the current at the second frequency exceeds the threshold value, setting the second frequency as an optimum frequency of the current of the coil.

### Advantageous Effects

According to embodiments of the present disclosure, an aerosol generating device applying an induction heating method and including various pieces of hardware is capable of easily finding an optimum frequency flowing through a coil.

### DESCRIPTION OF DRAWINGS

FIG. 1 is a diagram illustrating an example in which a cigarette is inserted into an aerosol generating device.

FIG. 2 is a diagram illustrating another example in which a cigarette is inserted into an aerosol generating device.

FIG. 3 is a diagram illustrating another example in which a cigarette is inserted into an aerosol generating device.

FIG. 4 is a diagram illustrating an example of a cigarette.

FIG. 5 is a diagram illustrating another example of a cigarette.

FIG. 6 is a diagram illustrating an example of a dual-media cigarette used in the aerosol generating device of FIG. 3.

FIG. 7 is a perspective view of an example of an aerosol generating device including a liquid cartridge.

FIG. 8 is a perspective view of an example of an aerosol generating device according to an embodiment of the present disclosure.

FIG. 9 is a side view of the aerosol generating device described in FIG. 8.

FIG. 10 is a block diagram of an example of a controller included in an aerosol generating device.

FIG. 11 is a graph of an example of a frequency response of an aerosol generating device according to an embodiment of the present disclosure.

FIG. 12 is a graph of a frequency response for describing another embodiment of the present disclosure.

FIG. 13 is a diagram for describing an example of a method, performed by a controller, of determining a second frequency range.

FIG. 14 is a flowchart of an example of a method of performing multicalibration on a temperature value measured by a temperature sensor, according to embodiments of the present disclosure.

FIG. 15 is a flowchart of another example of a method of performing multicalibration on a temperature value measured by a temperature sensor, according to embodiments of the present disclosure.

### BEST MODE

According to one or more embodiments, an aerosol generating device may be provided. The aerosol generating device may include: a coil configured to generate a magnetic field by a current flowing through the coil; a heater configured to be induction heated via the magnetic field; and a controller configured to control the current. The controller is further configured to change a frequency of the current flowing through the coil within a pre-set driving frequency range; and determine whether a magnitude of the current flowing through the coil exceeds a threshold value according to one or more changed frequencies of the current.

According to an embodiment, the controller may be further configured to sequentially change the frequency of the current in a pre-set unit, from a minimum frequency within the pre-set driving frequency range.

According to an embodiment, the threshold value may be 4 A.

According to an embodiment, the controller may be further configured to: search for an optimum frequency at which the current flowing through the coil has a magnitude that exceeds the threshold value and has a greatest value; and based on an input with respect to a power button being sensed, control the current to flow through the coil at the optimum frequency.

According to an embodiment, the controller may be further configured to determine the pre-set driving frequency range based on pieces of hardware included in the aerosol generating device.

According to one or more embodiments, an aerosol generating device may be provided. The aerosol generating device may include: a coil configured to generate a magnetic field by a current flowing through the coil; a heater configured to be induction heated via the magnetic field; and a controller configured to control the current, wherein the controller is further configured to: change a frequency of the current flowing through the coil within a pre-set first frequency range; based on a magnitude of the current flowing through the coil being less than a threshold value, with respect to frequencies included in the pre-set first frequency range, set a second frequency range; and determine whether the magnitude of the current flowing through the coil exceeds the threshold value, with respect to frequencies included in the second frequency range.

According to an embodiment, the controller may be further configured to determine the pre-set first frequency range based on pieces of hardware included in the aerosol generating device.

According to an embodiment, the threshold value may be 4 A.

According to an embodiment, the controller may be further configured to determine a minimum frequency and a maximum frequency of the second frequency range based on a ratio of the magnitude of the current of the coil to the frequency of the current flowing through the coil.

According to an embodiment, the minimum frequency may be included in the pre-set first frequency range.

According to an embodiment, the maximum frequency may be determined according to the minimum frequency.

According to an embodiment, the maximum frequency may be included in the pre-set first frequency range.

According to an embodiment, the minimum frequency may be determined according to the maximum frequency.

According to one or more embodiments, a method of optimizing a frequency of a current flowing through a coil of an aerosol generating device may be provided. The method includes: monitoring a magnitude of the current flowing through the coil, by changing the frequency within a pre-set driving frequency range; identifying a frequency, within the pre-set driving frequency range, at which the magnitude of the current of the coil has a greatest value; and determining whether the magnitude of the current at the identified frequency exceeds a threshold value.

According to an embodiment, the monitoring of the magnitude of the current may include changing the frequency within the pre-set driving frequency range according to a pre-set unit frequency.

According to an embodiment, the method may further include, based on an input with respect to a power button being sensed, controlling the current to flow through the coil at the identified frequency.

According to an embodiment, the pre-set driving frequency range may be set based on pieces of hardware included in the aerosol generating device.

According to one or more embodiments, a method of optimizing a frequency of a current flowing through a coil of an aerosol generating device may be provided. The method includes: monitoring a magnitude of the current flowing through the coil, by changing the frequency within a pre-set first frequency range; identifying a first frequency, within the pre-set first frequency range, at which the magnitude of the current of the coil has a greatest value; based on the magnitude of the current at the identified first frequency being less than a threshold value, setting a second frequency range; identifying a second frequency at which the magnitude of the current flowing through the coil has a greatest value, by changing the frequency within the second frequency range; and based on the magnitude of the current at the second frequency exceeding the threshold value, setting the second frequency as an optimum frequency of the current of the coil.

According to an embodiment, a minimum frequency and a maximum frequency of the second frequency range may be determined based on a ratio of the magnitude of the current of the coil to the frequency of the current flowing through the coil.

According to one or more embodiments, a computer-readable recording medium having stored thereon a program for executing a method of the present disclosure may be provided.

### MODE FOR INVENTION

With respect to the terms used to describe the various embodiments, general terms which are currently and widely used are selected in consideration of functions of structural elements in the various embodiments of the present disclosure. However, meanings of the terms can be according to intention, a judicial precedence, the appearance of new technology, and the like. There are terms discretionally selected on particular occasions. These terms will be explained in detail in relevant description. Therefore, terms used herein are not just names but should be defined based on the meaning of the terms and the whole content of the present disclosure.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and/or operation and can be implemented by hardware components or software components and combinations thereof.

The attached drawings for illustrating one or more embodiments are referred to in order to gain a sufficient understanding, the merits thereof, and the objectives accomplished by embodiments of the present disclosure. Embodiments may, however, be embodied in many different forms and should not be construed as being limited to the example embodiments set forth herein.

Hereinafter, embodiments of the present disclosure will be described in detail with reference to the drawings.

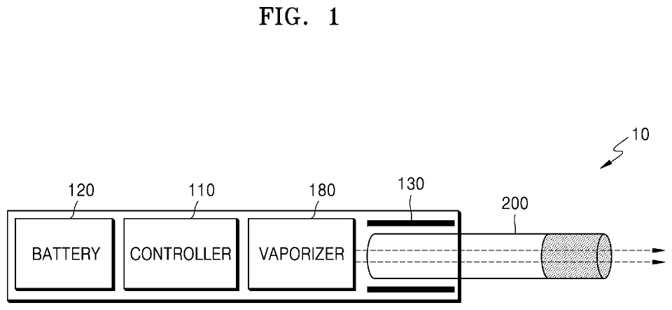

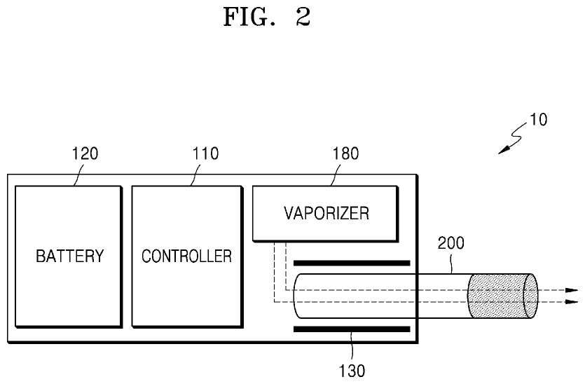

FIGS. 1 and 2 are diagrams showing examples in which a cigarette is inserted into an aerosol generating device.

Referring to FIGS. 1 and 2, an aerosol generating device 10 includes a battery 120, a controller 110, a heater 130 and a vaporizer 180. A cigarette 200 may be inserted into an internal space of the aerosol generating device 10.

Elements related to the embodiment are illustrated in the aerosol generating device 10 of FIGS. 1 to 2. However, one of ordinary skill in the art would appreciate that universal elements other than the elements shown in FIGS. 1 to 2 may be further included in the aerosol generating device 10.

In addition, although it is shown that the heater 130 is included in the aerosol generating device 10 in FIGS. 1 and 2, the heater 130 may be omitted according to some embodiments.

In FIG. 1, the battery 120, the controller 110, the heater 130 and the vaporizer 180 are arranged in a row. Also, FIG. 2 shows that the vaporizer 180 and the heater 130 are arranged in parallel with each other. However, an internal structure of the aerosol generating device 10 is not limited to the examples shown in FIG. 1 or 2. That is, according to a design of the aerosol generating device 10, arrangement of the battery 120, the controller 110, the heater 130, and the vaporizer 180 may be changed.

When the cigarette 200 is inserted into the aerosol generating device 10, the aerosol generating device 10 operates the heater 130 and/or the vaporizer 180 to generate aerosol from the cigarette 200 and/or the vaporizer 180. The aerosol generated by the vaporizer 180 may be transferred to a user via the cigarette 200. The vaporizer 180 will be described in more detail below.

The battery 120 supplies the electric power used to operate the aerosol generating device 10. For example, the battery 120 may supply power for heating the heater 130 or the vaporizer 180 and supply power for operating the controller 110. In addition, the battery 120 may supply power for operating a display, a sensor, a motor, and the like installed in the aerosol generating device 10.

The controller 110 controls the overall operation of the aerosol generating device 10. In detail, the controller 110 may control operations of other elements included in the aerosol generating device 10, as well as the battery 120, the heater 130, and the vaporizer 180. Also, the controller 110 may check the status of each component in the aerosol generating device 10 to determine whether the aerosol generating device 10 is in an operable state.

The controller 110 includes at least one processor. A processor may be implemented as an array of a plurality of logic gates or may be implemented as a combination of a general-purpose microprocessor and a memory in which a program executable by the microprocessor is stored. It will be understood by one of ordinary skill in the art that the controllers of the present disclosure may be implemented in other forms of hardware.

The heater 130 may be heated by the electric power supplied from the battery 120. For example, when the cigarette is inserted in the aerosol generating device 10, the heater 130 may be located outside the cigarette. Therefore, the heater 130 that is heated may raise the temperature of an aerosol generating material in the cigarette.

The heater 130 may be an electro-resistive heater. For example, the heater 130 includes an electrically conductive track, and the heater 130 may be heated as a current flows through the electrically conductive track. However, the heater 130 is not limited to the above example, and any type of heater may be used provided that the heater is heated to a desired temperature. Here, the desired temperature may be set in advance in the aerosol generating device 10, or may be set by a user.

In addition, in another example, the heater 130 may include an induction heating type heater. In detail, the heater 130 may include an electrically conductive coil for heating the cigarette in an induction heating method, and the cigarette may include a susceptor that may be heated by the induction heating type heater.

In FIGS. 1 and 2, the heater 130 is shown to be disposed outside the cigarette 200, but is not limited thereto. For example, the heater 130 may include a tubular heating element, a plate-shaped heating element, a needle-shaped heating element, or a rod-shaped heating element. And the inside or outside of the cigarette 200 can be heated by the heating element.

Also, there may be a plurality of the heater 130 in the aerosol generating device 10. Here, the plurality of the heater 130 may be arranged to be inserted into the cigarette 200 or on the outside of the cigarette 200. Also, some of the plurality of the heater 130 may be arranged to be inserted into the cigarette 200 and others may be arranged on the outside of the cigarette 200. In addition, the shape of the heater 130 is not limited to the example shown in FIGS. 1 and 2, but may be manufactured in various shapes.

The vaporizer 180 may generate aerosol by heating a liquid composition and the generated aerosol may be delivered to the user after passing through the cigarette 200. In other words, the aerosol generated by the vaporizer 180 may move along an air flow passage of the aerosol generating device 10, and the air flow passage may be configured for the aerosol generated by the vaporizer 180 to be delivered to the user through the cigarette.

For example, the vaporizer 180 may include a liquid storage unit, a liquid delivering unit, and a heating element, but is not limited thereto. For example, the liquid storage unit, the liquid delivering unit, and the heating element may be included in the aerosol generating device 10 as independent modules.

The liquid storage may store a liquid composition. For example, the liquid composition may be a liquid including a tobacco containing material including a volatile tobacco flavor component, or a liquid including a non-tobacco material. The liquid storage unit may be attached to/detached from the vaporizer 180 or may be integrally manufactured with the vaporizer 180.

For example, the liquid composition may include water, solvents, ethanol, plant extracts, flavorings, flavoring agents, or vitamin mixtures. The flavoring may include, but is not limited to, menthol, peppermint, spearmint oil, various fruit flavoring ingredients, etc. The flavoring agent may include components that may provide the user with various flavors or tastes. Vitamin mixtures may be a mixture of at least one of vitamin A, vitamin B, vitamin C, and vitamin E, but are not limited thereto. Also, the liquid composition may include an aerosol former such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivering unit. For example, the heating element may be a metal heating wire, a metal hot plate, a ceramic heater, or the like, but is not limited thereto. In addition, the heating element may include a conductive filament such as nichrome wire and may be wound around the liquid delivery element. The heating element may be heated by a current supply and may transfer heat to the liquid composition in contact with the heating element, thereby heating the liquid composition. As a result, aerosol may be generated.

For example, the vaporizer 180 may be referred to as a cartomizer or an atomizer, but is not limited thereto.

The aerosol generating device 10 may further include universal elements, in addition to the battery 120, the controller 110, the heater 130, and the vaporizer 180. For example, the aerosol generating device 10 may include a display capable of outputting visual information and/or a motor for outputting tactile information. In addition, the aerosol generating device 10 may include at least one sensor (a puff sensor, a temperature sensor, a cigarette insertion sensor, etc.). Also, the aerosol generating device 10 may be manufactured to have a structure, in which external air may be introduced or internal air may be discharged even in a state where the cigarette 200 is inserted.

Although not shown in FIGS. 1 and 2, the aerosol generating device 10 may configure a system with an additional cradle. For example, the cradle may be used to charge the battery 120 of the aerosol generating device 10. Alternatively, the heater 130 may be heated in a state in which the cradle and the aerosol generating device 10 are coupled to each other.

The cigarette 200 may be similar to a typical burning cigarette. For example, the cigarette 200 may include a first portion containing an aerosol generating material and a second portion including a filter and the like. Alternatively, the second portion of the cigarette 200 may also include the aerosol generating material. For example, an aerosol generating material made in the form of granules or capsules may be inserted into the second portion.

The entire first portion may be inserted into the aerosol generating device 10 and the second portion may be exposed to the outside. Alternatively, only a portion of the first portion may be inserted into the aerosol generating device 10 or the entire first portion and a portion of the second portion may be inserted into the aerosol generating device 10. The user may puff aerosol while holding the second portion with the mouth of the user. At this time, the aerosol is generated as the outside air passes through the first portion, and the generated aerosol passes through the second portion and is delivered to a user's mouth.

For example, the outside air may be introduced through at least one air passage formed in the aerosol generating device 10. For example, the opening and closing of the air passage formed in the aerosol generating device 10 and/or the size of the air passage may be adjusted by a user. Accordingly, the amount of smoke and a smoking impression may be adjusted by the user. In another example, the outside air may be introduced into the cigarette 200 through at least one hole formed in a surface of the cigarette 200.

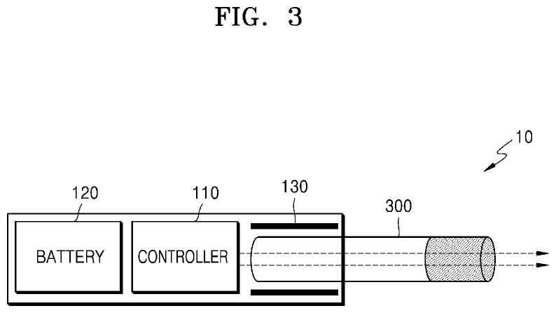

FIG. 3 is a diagram illustrating another example in which a cigarette is inserted into an aerosol generating device.

When the aerosol generating apparatus of FIG. 3 is compared with the aerosol generating apparatus described with respect to FIGS. 1 and 2, it can be seen that the vaporizer 180 is omitted. Since the element that performs the function of the vaporizer 180 is included in the double medium cigarette 300 inserted into the aerosol generating device shown in FIG. 3, the aerosol generating device shown in FIG. 3 does not include the vaporizer 180.

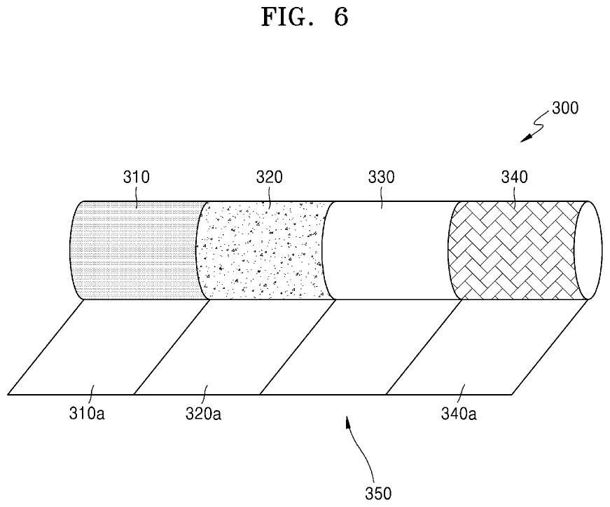

When the double medium cigarette 300 is inserted the aerosol generating device 10 in FIG. 3, the double medium cigarette 300 is externally heated, so that a user inhalable aerosol can be generated from the double medium cigarette 300. Also, the double medium cigarette 300 will be described with reference to FIG. 6.

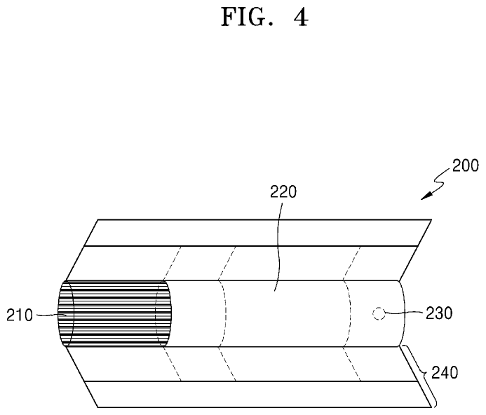

Hereinafter, an example of the cigarette 200 will be described with reference to FIG. 4.

FIG. 4 is a drawing illustrating an example of a cigarette.

Referring to FIG. 4, the cigarette 200 includes a tobacco rod 210 and a filter rod 220. The first portion described above with reference to FIGS. 1 to 2 includes the tobacco rod 210 and the second portion includes the filter rod 220.

In FIG. 4, the filter rod 220 is shown as a single segment, but is not limited thereto. In other words, the filter rod 220 may include a plurality of segments. For example, the filter rod 220 may include a first segment for cooling down the aerosol and a second segment for filtering a predetermined component included in the aerosol. Also, according to embodiments, the filter rod 220 may further include at least one segment performing another function.

The cigarette 200 may be packaged by at least one wrapper 240. The wrapper 240 may include at least one hole through which the outside air is introduced or inside air is discharged. For example, the cigarette 200 may be packaged by one wrapper 240. In another example, the cigarette 200 may be packaged by two or more wrappers 240. For example, the tobacco rod 210 may be packaged by a first wrapper and the filter rod 220 may be packaged by a second wrapper. In addition, the tobacco rod 210 and the filter rod 220 may be respectively packaged by single wrappers, and then, the cigarette 200 may be entirely re-packaged by a third wrapper. When each of the tobacco rod 210 and the filter rod 220 includes a plurality of segments, each of the segments may be packaged by a single wrapper. In addition, the cigarette 200, in which the segments respectively packaged by the single wrappers are coupled to one another, may be re-packaged by another wrapper.

The tobacco rod 210 includes an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. In addition, the tobacco rod 210 may include other additive materials like a flavoring agent, a wetting agent, and/or an organic acid. Also, a flavoring liquid such as menthol, humectant, etc. may be added to the tobacco rod 210 by being sprayed to the tobacco rod 210.

The tobacco rod 210 may be manufactured variously. For example, the tobacco rod 210 may be fabricated as a sheet or a strand. Also, the tobacco rod 210 may be fabricated by tobacco leaves that are obtained by fine-cutting a tobacco sheet. Also, the tobacco rod 210 may be surrounded by a heat conducting material. For example, the heat-conducting material may be, but is not limited to, a metal foil such as aluminum foil. For example, the heat conducting material surrounding the tobacco rod 210 may improve a thermal conductivity applied to the tobacco rod by evenly dispersing the heat transferred to the tobacco rod 210, and thus, improving tobacco taste. Also, the heat conducting material surrounding the tobacco rod 210 may function as a susceptor that is heated by an inducting heating-type heater. Although not shown in the drawings, the tobacco rod 210 may further include a susceptor, in addition to the heat conducting material surrounding the outside thereof.

The filter rod 220 may be a cellulose acetate filter. In addition, the filter rod 220 is not limited to a particular shape. For example, the filter rod 220 may be a cylinder-type rod or a tube-type rod including a cavity therein. Also, the filter rod 220 may be a recess type rod. When the filter rod 220 includes a plurality of segments, at least one of the plurality of segments may have a different shape from the others.

The filter rod 220 may be manufactured to generate flavor. For example, a flavoring liquid may be sprayed to the filter rod 220 or separate fibers on which the flavoring liquid is applied may be inserted in the filter rod 220.

Also, the filter rod 220 may include at least one capsule 230. Here, the capsule 230 may generate flavor or may generate aerosol. For example, the capsule 230 may have a structure, in which a liquid containing a flavoring material is wrapped with a film. The capsule 230 may have a circular or cylindrical shape, but is not limited thereto.

When the filter rod 220 includes a segment for cooling down the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above examples, and may include any material provided that a function of cooling down the aerosol is implemented.

Although not shown in FIG. 4, the cigarette 200 according to an embodiment may further include a front-end filter. The front-end filter is at a side facing the filter rod 220, in the tobacco rod 210. The front-end filter may prevent the tobacco rod 210 from escaping to the outside and may prevent the liquefied aerosol from flowing to the aerosol generating device 10 (see FIGS. 1 to 2) from the tobacco rod 210 during smoking.

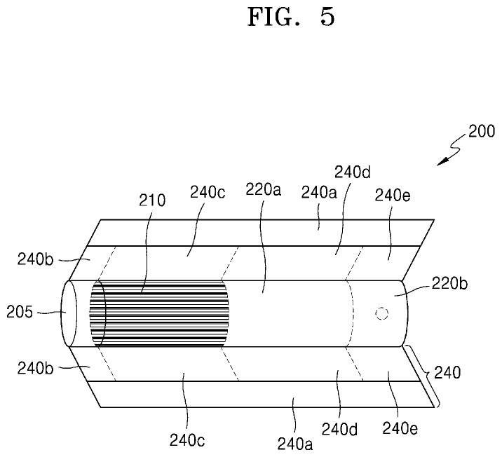

FIG. 5 is a view illustrating another example of a cigarette.

Referring to FIG. 5, it can be seen that the cigarette 200 has a form in which a cross tube 205, the tobacco rod 210, a tube 220a, and a filter 220b are wrapped by a plurality of wrappers 240, including a final wrapper 240a. In FIG. 5, the plurality of wrappers 240 includes individual wrappers that are individually wrapped around the cross tube 205, the tobacco rod 210, the tube 220a, and the filter 220b, and the final wrapper 240a that is collectively wrapped around the cross tube 205, the tobacco rod 210, the tube 220a, and the filter 220b.

The first portion described above with reference to FIGS. 1 and 2 includes the cross tube 205 and the tobacco rod 210, and the second portion includes the filter rod 220. For the sake of convenient description, the following description will be made with reference to FIGS. 1 and 2, and description overlapping with the description made with reference to FIG. 4 may be omitted.

The cross tube 205 refers to a cross-shaped tube connected to the tobacco rod 210.

The tobacco rod 210 includes an aerosol generating substrate that generates an aerosol by being heated by the heater 130 of the aerosol generation device 10.

The tube 220a performs a function of transferring an aerosol generated when an aerosol generating substrate of the tobacco rod 210 is heated by receiving the sufficient amount of energy from the heater 130 to the filter 220b. The tube 220a is manufactured in a manner in which triacetin (TA) which a plasticizer is added to a cellulose acetate tow by more than a certain amount to form a circle, and not only is different in shape but also has a difference in arrangement in that the tobacco rod 210 and the filter 220b are connected to each other, as compared with the cross tube 205.

When the aerosol generated by the tobacco rod 210 is transferred through the tube 220a, the filter 220b performs a function of allowing a user to puff the aerosol filtered by the filter 220b by passing the aerosol therethrough. The filter 220b may include a cellulose acetate filter manufactured based on a cellulose acetate tow.

The final wrapper 240a is paper that is wrapped around the cross tube 205, the tobacco rod 210, the tube 220a, and the filter 220b, and may include all of a cross tube wrapper 240b, a tobacco rod wrapper 240c, a tube wrapper 240d, and a filter wrapper 240e.

In FIG. 5, the cross tube wrapper 240b is an aluminum wrapper, the tube wrapper 240d is an MFW or 24K wrapper, and the filter wrapper 240e is an oil-resistant hard wrapper or a lamination of a poly lactic acid (PLA) material. The tobacco rod wrapper 240c and the final wrapper 240a will be described in more detail below.

The tobacco rod wrapper 240c is wrapped around the tobacco rod 210 and may be coated with a thermal conductivity enhancement material to maximize efficiency of thermal energy transferred by the heater 130. For example, the tobacco rod wrapper 240c may be manufactured in a manner in which a general wrapper or heterotype base paper is coated with at least one of silver foil (Ag), aluminum foil (Al), copper foil (Cu), carbon paper, filler, ceramic (AlN, Al₂O₃), silicon carbide, sodium citrate (Na citrate), potassium citrate (K citrate), aramid fiber, nano cellulose, mineral paper, glassine paper, and single-walled carbon nanotube (SWNT). A general wrapper refers to a wrapper applied to widely known cigarettes and refers to a porous wrapper made of a proven material that has both paper manufacturing workability and a thermal conductivity exceeding a certain value through a water paper test.

In addition, in embodiments of the present disclosure, the final wrapper 240a may be manufactured in a manner in which an MFW (a kind of steriled paper) base paper is coated with at least one of filler, ceramic, silicon carbide, sodium citrate, potassium citrate, aramid fiber, nano cellulose, and SWNT among various materials coating the tobacco rod wrapper 240c.

The heater 130 included in the aerosol generation device 10, that is externally heated as described with reference to FIGS. 1 and 2, is a target controlled by the controller 110, and heats the aerosol generating substrate included in the tobacco rod 210 to generate an aerosol, and at this time, thermal energy transferred to the tobacco rod 210 is composed of a ratio of 75% by radiant heat, 15% by convective heat, and 10% by conductive heat. The ratio between the radiant heat, the convective heat, and the conductive heat constituting the thermal energy transferred to the tobacco rod 210 may be different depending on the embodiment.

In embodiments of the present disclosure, in order to overcome the difficulty in quickly generating an aerosol because thermal energy may not be transferred with the heater 130 in direct contact with an aerosol generating substrate, the tobacco rod wrapper 240c and the final wrapper 240a are coated with a thermal conductivity enhancement material to prompt an efficient transfer of the thermal energy to the aerosol generating substrate of the tobacco rod 210, and thus, a sufficient amount of aerosol may be provided to a user even during an initial puff before the heater 130 is sufficiently heated.

Depending on the embodiment, only one of the tobacco rod wrapper 240c and the final wrapper 240a may also be coated with a thermal conductivity enhancement material, and embodiments of the present disclosure may also be implemented in a manner in which the tobacco rod wrapper 240c or the final wrapper 240a is coated with organic metal, inorganic metal, fiber, or polymer material which has a thermal conductivity of a preset value, as well as the above-described examples.

FIG. 6 is an example of a double medium cigarette used in the device of FIG. 3.

In FIG. 6, the double medium cigarette is named not only for the purpose of distinguishing from the cigarettes described in FIGS. 4 and 5, but also for concise description of embodiments of the present disclosure.

Referring the FIG. 6, the double medium cigarette 300 has an aerosol base portion 310, a medium portion 320, cooling portion 330, and a filter portion 340, which are wrapped by a final wrapper 350. The aerosol base portion 310, the medium portion 320, and the filter portion 340 are wrapped by individual wrappers, and the final wrapper 350 wraps the individual wrappers. The individual wrappers may include a first wrapper 310a, a second wrapper 320a, and a third wrapper 340a.

The aerosol base portion 310 is formed into a predetermined shape by containing a humectant in pulp-based paper. The aerosol base portion 310 may comprise propylene glycol or glycerin as the humectant. The humectant of the aerosol base portion 310 may comprise, propylene glycol, and glycerin having a certain weight ratio to the weight of the base paper. When the double medium cigarette 300 is inserted into the aerosol generating device 10 of FIG. 3, the aerosol base portion 310 is located closest to the heater 130.

When the aerosol base portion 310 is heated to a certain temperature by the heater 130, it generates moisture vapor.

The medium portion 320 comprises one or more of a sheet, a strand, and tobacco leaves that are obtained by fine-cutting a tobacco sheet, and is a portion that generates nicotine to provide a smoking experience to a user. The medium portion 320 is not directly heated from the heater 130, even if the double medium cigarette 300 is inserted into the aerosol generating device 10 of FIG. 3.

The medium portion 320 can be heated indirectly by conduction, convection, and radiation from the media wrapper (or final wrapper 350) wrapping the aerosol base portion 310 and the medium portion 320. In embodiments of the present disclosure, in consideration of the characteristic that the temperature to which the medium contained in the medium portion 320 must reach is lower than the temperature to which the humectant included in the aerosol base portion 310 must reach, the aerosol base portion 310 is heated with the heater 130 to indirectly increase the temperature of the medium portion 320. When the medium portion 320 is heated to a certain temperature by the heater 130, it generates nicotine vapor.

According to a specific embodiment, when the double medium cigarette 300 is inserted into the aerosol generating device 10 of FIG. 3, a part of the medium portion 320 may face the heater 130.

The cooling portion 330 is made of a tube filter containing a plasticizer with a predetermined weight. The moisture vapor from the aerosol base portion 310 and the nicotine vapor from the medium portion 320 are mixed to be aerosolized, are cooled while passing through the cooling portion 330.

Unlike the other portions, the cooling portion 330 is not wrapped by an individual wrapper.

The filter portion 340 may be a cellulose acetate filter, and the filter portion 340 is not limited to a particular shape. For example, the filter portion 340 may be a cylinder-type rod or a tube-type rod including a cavity therein. When the filter portion 340 includes a plurality of segments, at least one of the plurality of segments may have a different shape from the others. The filter portion 340 may be manufactured to generate flavor. For example, a flavoring liquid may be sprayed to the filter portion 340 or separate fibers on which the flavoring liquid is applied may be inserted in the filter portion 340.

Also, the filter portion 340 may include at least one capsule. Here, the capsule may generate flavor or may generate aerosol. For example, the capsule may have a structure, in which a liquid containing a flavoring material is wrapped with a film. The capsule may have a circular or cylindrical shape, but is not limited thereto.

The final wrapper 350 means a wrapper wrapping the aerosol base portion 310 that is wrapped by the first wrapper 310a, the medium portion 320 that is wrapped by the second wrapper 320a, the cooling portion 330, and the filter portion 340 that is wrapped by the third wrapper 340a.

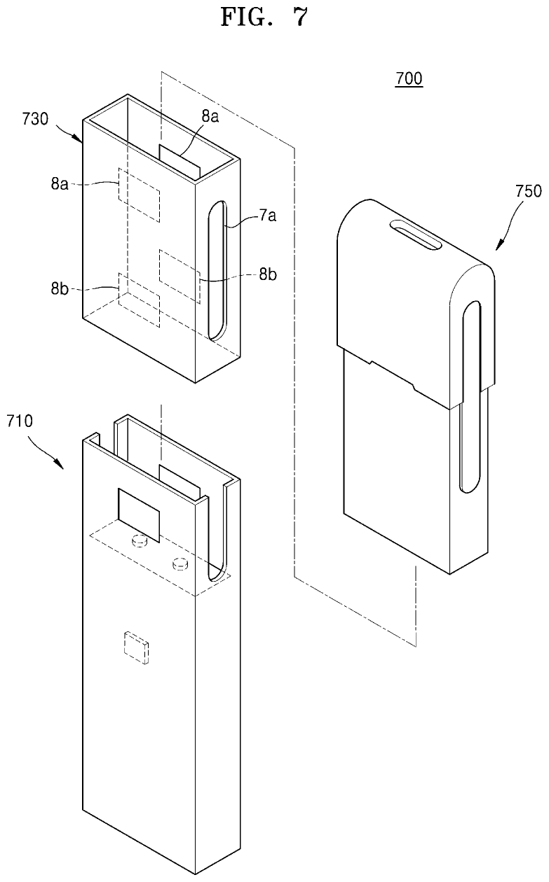

FIG. 7 is a perspective view of an example of an aerosol generating device including a liquid cartridge.

FIG. 7 is an exploded perspective view schematically illustrating a coupling relationship between a cartridge 750, that is replaceable and contains an aerosol generating material, and an aerosol generating device 700 including the same, according to an embodiment. An aerosol generating device 700 according to the embodiment illustrated in FIG. 7 includes the cartridge 750 containing the aerosol generating material and a main body 710 supporting the cartridge 750.

The cartridge 750 may be coupled to the main body 710 in a state in which the aerosol generating material is accommodated therein. A portion of the cartridge 750 is inserted into an accommodation space of the main body 710 so that the cartridge 750 may be mounted on the main body 710.

The cartridge 750 may contain an aerosol generating material in any one of, for example, a liquid state, a solid state, a gaseous state, or a gel state. The aerosol generating material may include a liquid composition. For example, the liquid composition may be a liquid including a tobacco-containing material having a volatile tobacco flavor component, or a liquid including a non-tobacco material.

For example, the liquid composition may include one component of water, solvents, ethanol, plant extracts, spices, flavorings, and vitamin mixtures, or a mixture of these components. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for the formation of the nicotine salts may be appropriately selected in consideration of the rate of nicotine absorption in the blood, the operating temperature of the aerosol generating device 700, the flavor or savor, the solubility, or the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid, and malic acid, or a mixture of two or more acids selected from the group, but is not limited thereto.

The cartridge 750 is operated by an electrical signal or a wireless signal transmitted from the main body 710 to perform a function of generating aerosol by converting the phase of the aerosol generating material inside the cartridge 750 to a gaseous phase. The aerosol may refer to a gas in which vaporized particles generated from an aerosol generating material are mixed with air.

For example, the cartridge 750 may convert the phase of the aerosol generating material by receiving the electrical signal from the main body 710 and heating the aerosol generating material, or by using an ultrasonic vibration method, or by using an induction heating method. As another example, when the cartridge 750 includes its own power source, the cartridge 750 may generate aerosol by being operated by an electric control signal or a wireless signal transmitted from the main body 710 to the cartridge 750.

The cartridge 750 may include a liquid storage accommodating the aerosol generating material therein, and an atomizer performing a function of converting the aerosol generating material of the liquid storage to aerosol.

When the liquid storage “accommodates the aerosol generating material” therein, it means that the liquid storage functions as a container simply holding an aerosol generating material and that the liquid storage includes therein an element impregnated with (containing) an aerosol generating material, such as a sponge, cotton, fabric, or porous ceramic structure.

The atomizer may include, for example, a liquid delivery element (wick) for absorbing the aerosol generating material and maintaining the same in an optimal state for conversion to aerosol, and a heater heating the liquid delivery element to generate aerosol.

The liquid delivery element may include at least one of, for example, a cotton fiber, a ceramic fiber, a glass fiber, and porous ceramic.

The heater may include a metallic material such as copper, nickel, tungsten, or the like to heat the aerosol generating material delivered to the liquid delivery element by generating heat using electrical resistance. The heater may be implemented by, for example, a metal wire, a metal plate, a ceramic heating element, or the like, and may be implemented by a conductive filament, wound on the liquid delivery element, or arranged adjacent to the liquid delivery element, by using a material such as a nichrome wire.

In addition, the atomizer may be implemented by a heating element in the form of a mesh or plate, which performs both the functions of absorbing the aerosol generating material and maintaining the same in an optimal state for conversion to aerosol without using a separate liquid delivery element and the function of generating aerosol by heating the aerosol generating material.

At least a portion of the liquid storage of the cartridge 750 may include a transparent material so that the aerosol generating material accommodated in the cartridge 750 may be visually identified from the outside. The liquid storage includes a protruding window protruding from the liquid storage, so that the liquid storage may be inserted into a groove of the main body 710 when coupled to the main body 710. A mouthpiece and the liquid storage may be entirely formed of transparent plastic or glass, or only the protruding window corresponding to a portion of the liquid storage may be formed of a transparent material.

The main body 710 includes a connection terminal arranged inside the accommodation space. When the liquid storage of the cartridge 750 is inserted into the accommodation space of the main body 710, the main body 710 may provide power to the cartridge 750 through the connection terminal or supply a signal related to an operation of the cartridge 750 to the cartridge 750.

The mouthpiece is coupled to one end of the liquid storage of the cartridge 750. The mouthpiece is a portion of the aerosol generating device 700, which is to be inserted into a user's mouth. The mouthpiece includes a discharge hole for discharging aerosol generated from the aerosol generating material inside the liquid storage to the outside.

A slider 730 is coupled to the main body 710 to move with respect to the main body 710. The slider 730 covers at least a portion of the mouthpiece of the cartridge 750 coupled to the main body 710 or exposes at least a portion of the mouthpiece to the outside by moving with respect to the main body 710. The slider 730 includes an elongated hole 7a exposing at least a portion of the protruding window of the cartridge 750 to the outside.

The slider 730 has a container shape with a hollow space therein and both ends opened. The structure of the slider 730 is not limited to the container shape as shown in FIG. 7, and the slider 730 may have a bent plate structure having a clip-shaped cross-section, which is movable with respect to the main body 710 while being coupled to an edge of the main body 710, or a structure having a curved semi-cylindrical shape and a curved arc-shaped cross section.

The slider 730 includes a magnetic body for maintaining the position of the slider 730 with respect to the main body 710 and the cartridge 750. The magnetic body may include a permanent magnet or a material such as iron, nickel, cobalt, or an alloy thereof.

The magnetic body includes two first magnetic bodies 8a facing each other with an inner space of the slider 730 therebetween, and two second magnetic bodies 8b facing each other with the inner space of the slider 730 therebetween. The first magnetic bodies 8a and the second magnetic bodies 8b are arranged to be spaced apart from each other along a longitudinal direction of the main body 710, which is a moving direction of the slider 730, that is, the direction in which the main body 710 extends.

The main body 710 includes a fixed magnetic body arranged on a path along which the first magnetic bodies 8a and the second magnetic bodies 8b of the slider 730 move while the slider 730 moves with respect to the main body 710. Two fixed magnetic bodies of the main body 710 may be mounted to face each other with the accommodation space therebetween.

Depending on the position of the slider 730, the slider 730 may be stably maintained in a position where an end of the mouthpiece is covered or exposed by a magnetic force acting between the fixed magnetic body and one of the first magnetic bodies 8a or between the fixed magnetic body and one of the second magnetic bodies 8b.

The main body 710 includes a position change detecting sensor arranged on the path along which at least one of the first magnetic bodies 8a and at least one of the second magnetic bodies 8b of the slider 730 move while the slider 730 moves with respect to the main body 710. The position change detecting sensor may include, for example, a Hall IC using the Hall effect that detects a change in a magnetic field and generates a signal.

In the aerosol generating device 700 according to the above-described embodiments, the main body 710, the cartridge 750, and the slider 730 have approximately rectangular cross-sectional shapes in a direction transverse to the longitudinal direction, but in embodiments, the shape of the aerosol generating device 700 is not limited. The aerosol generating device 700 may have, for example, a cross-sectional shape of a circle, an ellipse, a square, or various polygonal shapes. In addition, the aerosol generating device 700 is not necessarily limited to a structure that extends linearly when extending in the longitudinal direction, and may extend a long way while being curved in a streamlined shape or bent at a preset angle in a specific area to be easily held by the user.

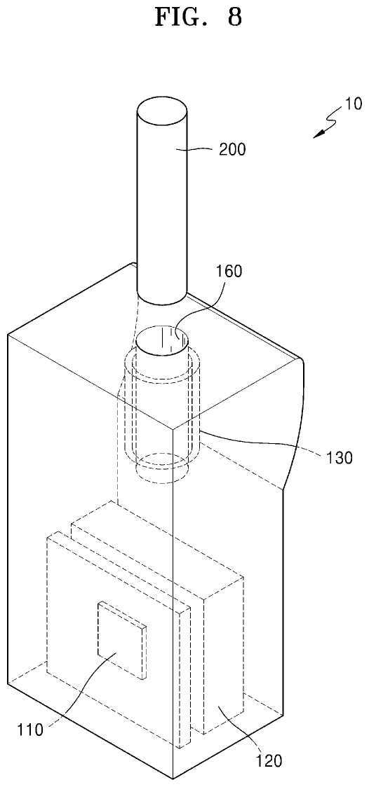

FIG. 8 is a perspective view of an example of an aerosol generating device according to embodiments of the present disclosure.

Referring to FIG. 8, it may be seen that the aerosol generating device 10 according to embodiments of the present disclosure includes a controller 110, a battery 120, a heater 130, and a cigarette 200. FIG. 8 shows only a partial configuration of the aerosol generating device 10 by emphasizing for convenience of description. Therefore, it will be apparent to those of ordinary skill in the art that other configurations may be added without departing from the scope of the present disclosure.

In addition, the internal structure of the aerosol generating device 10 is not limited to that shown in FIG. 8, and depending on an embodiment or design, the arrangement of the controller 110, the battery 120, the heater 130, and the cigarette 200 may be different. Description of each element of FIG. 8 has already been given with reference to FIGS. 1 to 6, and thus will be omitted.

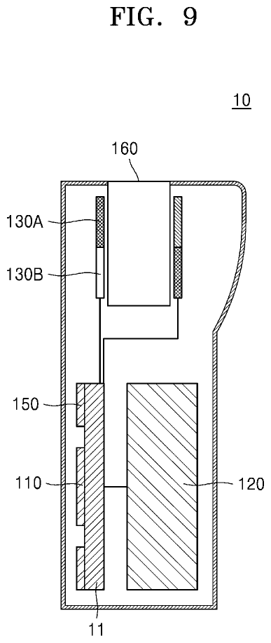

FIG. 9 is a side view of the device described in FIG. 8.

Referring to FIG. 9, the aerosol generating device 10 according to embodiments of the present disclosure includes a printed circuit board (PCB) 11, a controller 110, a battery 120, a heater 130, and a display 150, and a cigarette insertion space 160. Hereinafter, descriptions that are the same as those of the configuration described with reference to FIG. 1 may be omitted.

The PCB 11 performs a function of electronically integrating various components that collect information of the aerosol generating device 10 while communicating with the controller 110. The controller 110 and the display 150 may be fixedly mounted on the surface of the PCB 11, and the battery 120 supplies power to elements connected to the PCB 11.

The display 150 is a device that controls information for a user to be output as visual information among information generated by the aerosol generating device 10, and controls information output to an LCD panel (or LED panel) provided on a front side of the aerosol generating device 10 based on information received from the controller 110.

The cigarette insertion space 160 refers to a space that is recessed to a predetermined depth toward the inside of the aerosol generating device 10 so that the cigarette 200 is inserted. The cigarette insertion space 160 has a cylindrical form like the shape of cigarette 200 so that the cigarette 200, that is stick-shaped, is stably mounted, and the height (depth) of the cigarette insertion space 160 may vary depending on the length of the region of the cigarette 200 containing the aerosol-generating material.

For example, if the double medium cigarette 300 described with reference to FIG. 6 is inserted into the cigarette insertion space 160, the height of the cigarette insertion space 160 may be equal to the sum of the lengths of the aerosol substrate portion 310 and the medium portion 320. When the cigarette 200 is inserted into the cigarette insertion space 160, an aerosol may be generated as the heater 130 adjacent to the cigarette insertion space 160 is heated.

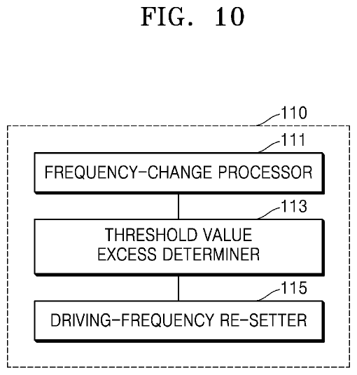

FIG. 10 is a block diagram of an example of the controller 110 included in the aerosol generating device 10.

Referring to FIG. 10, the controller 110 included in the aerosol generating device 10 includes a frequency-change processor 111, a threshold value excess determiner 113, and a driving-frequency re-setter 115. The controller 110 may include at least one processor to implement the frequency-change processor 111, the threshold value excess determiner 113, and the driving-frequency re-setter 115, or the frequency-change processor 111, the threshold value excess determiner 113, and the driving-frequency re-setter 115 may include at least one processor to implement their respective functions. The at least one processor can be implemented as an array of a plurality of logic gates or can be implemented as a combination of a general-purpose microprocessor and a memory in which a program executable in the microprocessor is stored. Also, it would be understood by one of ordinary skill in the art that the controller 110, the frequency-change processor 111, the threshold value excess determiner 113, and the driving-frequency re-setter 115 of FIG. 10 may be implemented as different forms of hardware.

The frequency-change processor 111 changes a frequency of a current flowing through a coil, within a pre-set driving frequency range. Here, a unit in which the frequency is changed is based on a unit frequency value that is pre-set. For example, when a unit frequency is 500 Hz, the frequency-change processor 111 may add increments of 500 Hz to a minimum frequency included in the driving frequency range so as to sequentially or randomly change the frequency of the current flowing through the coil.

When a frequency is specified, and when a current of the specified frequency flows through the coil, the threshold value excess determiner 113 determines whether or not a magnitude of the current flowing through the coil exceeds a threshold value.

When frequencies at which the magnitudes of the current flowing through the coil exceed a threshold value are not detected in a pre-set driving frequency range, the driving-frequency re-setter 115 performs an operation of setting a new driving frequency range.

The name of each module described above is given to intuitively describe the functions performed by the controller 110. According to embodiments, the name of each module may be changed. Also, it would be understood by one of ordinary skill in the art that the function performed by each module may be solely implemented by the controller 110. Thus, hereinafter, embodiments of the present disclosure will be described in detail, and for convenience of explanation, an object performing each function is considered to be the controller 110, unless particularly defined.

The aerosol generating device 10 according to embodiments of the present disclosure includes a coil, a heater, and the controller 110, wherein the controller 110 is configured to control a current of the coil and generate various control signals. In the present disclosure, the heater may be also referred to as a susceptor, and the aerosol generating device is considered to be a device for generating aerosol by applying an induction heating method.

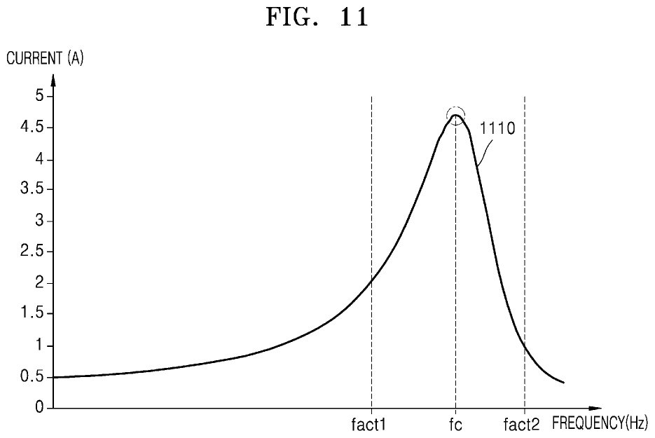

FIG. 11 is a graph of an example of a frequency response of an aerosol generating device according to embodiments of the present disclosure.

An aerosol generating device according to an embodiment of the present disclosure may include various pieces of hardware that have a resistance, an inductance, or a capacitance. For example, the aerosol generating device may include a resistor, inductor, or a capacitor (RLC) circuit including a passive device. FIG. 11 illustrates the frequency response in the RLC circuit, and an x axis indicates a frequency of a current flowing through a coil and a y axis indicates a magnitude of the current flowing through the coil.

To analyze the graph 1110 showing the magnitude of the current according to a change of the frequency, there is a tendency that as a value of the frequency is increased, the magnitude of the current flowing through the coil is also increased. However, after the frequency reaches a resonant frequency f_{c}, there is a tendency that as the value of the frequency is increased, the magnitude of the current flowing through the coil is rather decreased. When various pieces of hardware included in the aerosol generating device are configured as passive devices or impedances corresponding thereto, a resonant frequency may be searched according to a known arithmetic formula. However, due to consumable supplies (an aerosol generating substrate) included in the aerosol generating device, components that are detachable from the aerosol generating device, and accessories, a structure of the hardware of the aerosol generating device may be variously changed, and whenever the structure is changed, the resonant frequency f_{c} may also be changed.

In FIG. 11, the range of frequencies between frequencies f_{act1} and f_{act2} may be referred to as a “driving frequency range,” and the frequency f_{act1} may be referred to as a minimum frequency among frequencies included in the driving frequency range and the frequency f_{act2} may be referred to as a maximum frequency among the frequencies included in the driving frequency range.

Here, the driving frequency range may be a range of values that is determined based on a result of sensing, via the controller 110 and the hardware included in the aerosol generating device 10. For example, the controller 110 may manage the types and the number of components included in the aerosol generating device 10 and may calculate the driving frequency range according thereto by using a series of arithmetic formulas. When various accessories to be mounted on or released from the aerosol generating device 10 include conductive materials or electronic devices, the total impedance of the aerosol generating device 10 may be affected, and thus, the driving frequency range may be changed. Once the driving frequency range is determined, the frequency of the current flowing through the coil may be limited to frequencies selected within the driving frequency range, in order to secure the operational stability of the aerosol generating device 10.

The aerosol generating device according to an embodiment of the present disclosure may include a coil through which a current flows, an inductive heater using a magnetic field generated by the current, and a controller configured to control the current. Here, the controller may change the frequency of the current flowing through the coil within a pre-set driving frequency range, and may determine, according to one or more of changed frequencies, whether or not a magnitude(s) of the current flowing through the coil exceed(s) a threshold value.

Referring to FIG. 11, the driving frequency range may be pre-set as the range between the frequencies f_{act1} and f_{act2}, and the controller 110 may monitor a change in the magnitude of the current flowing through the coil by changing the frequency within the driving frequency range. In FIG. 11, when a threshold value is 4 A, and when the magnitude of the current flowing through the coil exceeds 4 A, the controller 110 may determine that the magnitude of the current flowing through the coil exceeds the threshold value. Further, the controller 110 may set a frequency at which the magnitude of the current flowing through the coil exceeds 4 A as a frequency for the aerosol generating device to stably operate. In particular, the controller 110 may determine a frequency at which the magnitude of the current flowing through the coil has a greatest value as a resonant frequency, and may use the resonant frequency. Hereinafter, the resonant frequency may alternatively be referred to as an optimum frequency.

When a magnitude of the current flowing through the coil at a particularly frequency exceeds a threshold value, the controller 110 may determine that the heating efficiency of the aerosol generating device 10 is normal. When magnitudes of the current flowing through the coil do not exceed the threshold value at any frequencies within the driving frequency range, the controller 110 may determine that the heating efficiency of the aerosol generating device 10 at the frequencies is defective.

These determinations of the controller 110 may be performed whenever the aerosol generating device 10 operates, that is, whenever the heater of the aerosol generating device 10 is heated. For example, when a user applies an input with respect to a power button to smoke through the aerosol generating device 10, the controller 110 may sense the input with respect to the power button and control the current to flow through the coil according to the optimum frequency. Here, as described above, the optimum frequency is a frequency value that is selected within the driving frequency range through the series of processes described above.

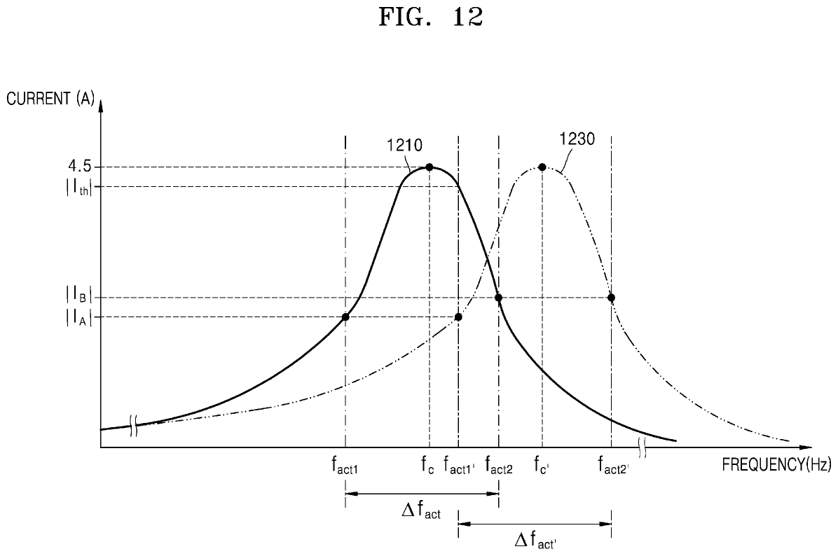

FIG. 12 is a graph of a frequency response for describing another embodiment of the present disclosure.

In FIG. 12, a first frequency response 1210 is a frequency response determined in a process of manufacturing the aerosol generating device 10, and is an ideal graph calculated in a state in which no other pieces of hardware are mounted in the aerosol generating device 10. Based on the first frequency response 1210, an optimum frequency is f_{c}, and a driving frequency range is β_{fact}. In the first frequency response 1210, a threshold value |Iₜₕ| is 4 A, and when a magnitude of a current flowing through a coil exceeds the threshold value, the controller 110 may determine that the heating efficiency of the aerosol generating device 10 is good.

In FIG. 12, a second frequency response 1230 is a frequency response of a state in which the optimum frequency is changed because there is a change in hardware based on mounting of additional hardware in the aerosol generating device 10 or other various factors. Referring to FIG. 12, in the second frequency response 1230, while the threshold value |Iₜₕ| is still 4 A, the optimum frequency is changed to f_{c′}, and the driving frequency range is changed to β_{fact′}. In more detail, in a state in which the second frequency response 1230 is calculated, even when the frequency flowing through the coil is f_{c}, the magnitude of the current flowing through the coil does not exceed the threshold value, and the driving frequency range is changed. That is, in the state in which the second frequency response 1230 is calculated, the controller 110 has to find a new optimum frequency in the new driving frequency range β_{fact′}, in order to recover the heating efficiency of the aerosol generating device 10, which is the same level as the heating efficiency of the aerosol generating device 10 in the first frequency response 1210.

The controller 110 may change the frequency of the current flowing through the coil within a first frequency range that is pre-set, and when the magnitude of the current flowing through the coil is less than the threshold value with respect to frequencies included in the first frequency range, the controller may set a second frequency range. The controller 110 may determine whether the magnitude of the current flowing through the coil exceeds the threshold value with respect to frequencies included in the second frequency range, and when the magnitude exceeds the threshold value, the controller 110 may consider that an optimum frequency is found, and may determine that the heating efficiency of the aerosol generating device 10 is good.

In contrast, when the controller 110 determines that the magnitude of the current flowing through the coil is less than the threshold value with respect to all frequencies included in the second frequency range, the controller 110 may determine that the aerosol generating device 10 is defective and is incapable of obtaining the heating efficiency of a certain level by using only a software operation of the controller 110.

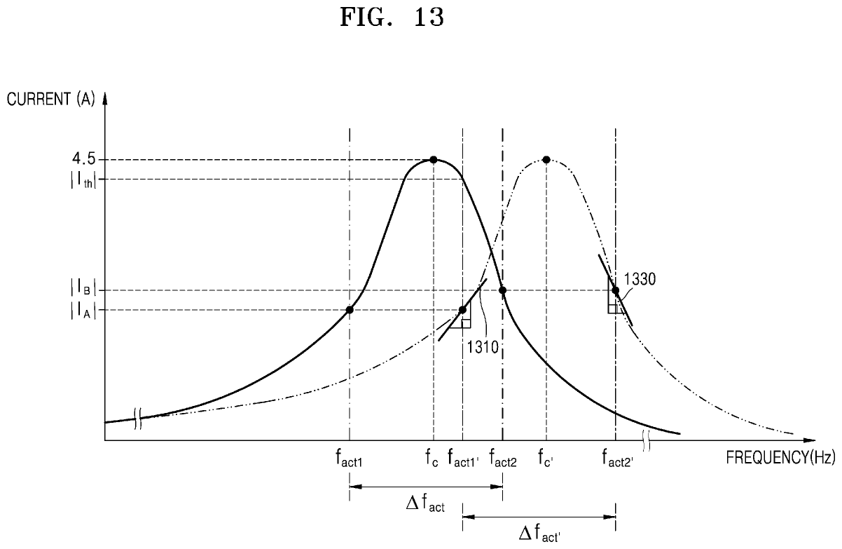

FIG. 13 is a diagram for describing an example of a method of determining the second frequency range via the controller 110.

The controller 110 may determine a minimum frequency f_{act1′} and a maximum frequency f_{act2′} of the second frequency range based on a ratio of a magnitude of a current flowing through a coil to a frequency of the current flowing through the coil. The ratio of the magnitude of the current flowing through the coil to the frequency of the current flowing through the coil is indicated at a first point 1310 and a second point 1330 in FIG. 13. Referring to FIG. 13, for example, the controller 110 may search for a ratio at which the magnitude of the current flowing through the coil at the frequency f_{act1′} is changed to |I_{A}|, and when the searched ratio corresponds to a pre-set reference, the controller 110 may determine the frequency f_{act1′} as the minimum frequency of the second frequency range. Also, by using substantially the same method, the controller 110 may determine the maximum frequency f_{act2′} of the second frequency range based on the magnitude of current flowing through the coil being |I_{B}|.

The second frequency range is different from the first frequency range. In order to reduce a search time during which the magnitude of the current flowing through the coil is identified by changing the frequency, the controller 110 changes the frequency only within a pre-set frequency range. Here, as the search area is changed from the first frequency range to the second frequency range, an optimum frequency f_{c′}, which is not searched within the first frequency range, may be searched.

As illustrated in FIGS. 12 and 13, the minimum frequency f_{act1′} of the second frequency range may be included in the first frequency range, and in this case, the maximum frequency f_{act2′} of the second frequency range is not included in the first frequency range. In contrast, the maximum frequency f_{act2′} of the second frequency range may be included in the first frequency range, and in this case, the minimum frequency f_{act1′} of the second frequency range is not included in the first frequency range.

Also, according to an embodiment, when any one of the minimum frequency and the maximum frequency in the second frequency range is determined, the controller 110 may apply a predetermined offset to the determined frequency to determine the other frequency and define the second frequency range, thereby minimizing the amount of calculations.

As described with reference to FIGS. 11 through 13, according to an embodiment of the present disclosure, there is provided a method of optimizing a frequency of a current flowing through a coil in the aerosol generating device 10 using induction heating. In detail, the method according to an embodiment of the present disclosure may include pre-setting a driving frequency range and searching for various frequencies within the driving frequency range, based on whether a magnitude of a current, which is greater than a threshold value, is sensed. When frequencies at which the magnitude of the current exceeds the threshold value are searched, an optimum frequency is determined among the frequencies, and the heating efficiency of the aerosol generating device may be maximized based on the frequency.

According to an additional embodiment, there is provided a method of secondarily re-setting a driving frequency range by performing a series of processes, when an optimum frequency is not searched within a primarily set driving frequency range. According to the additional embodiment, when a resonant frequency (an optimum frequency) for maximizing the heating efficiency is changed due to a change in hardware of the aerosol generating device 10, a new driving frequency range may be rapidly set, and a new optimum frequency may be searched within the range, and it may be determined whether the aerosol generating device 10 is good or defective.

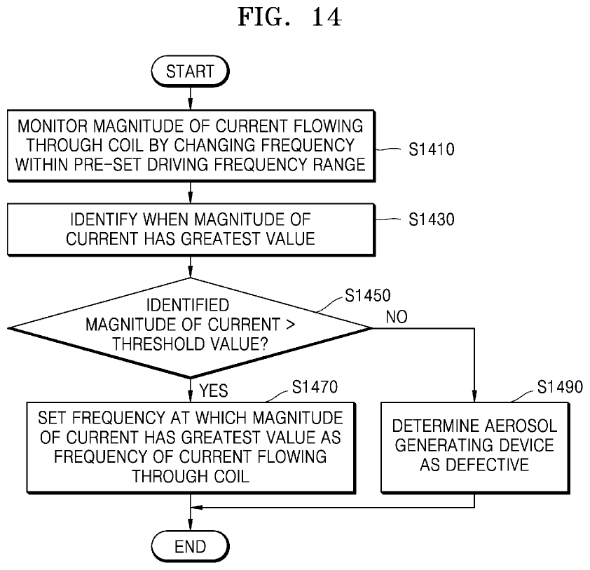

FIG. 14 is a flowchart of an example of a method of performing multicalibration on a temperature value measured by a temperature sensor, according to an embodiment of the present disclosure.

FIG. 14 may be implemented by the aerosol generating device 10 or the controller 110 previously described, and thus, descriptions will be given based on the aerosol generating device 10 or the controller 110. Hereinafter, aspects that are the same as the aspects described above will not be described.

The controller 110 may monitor a magnitude of a current flowing through a coil by changing a frequency within a pre-set driving frequency (S1410).

The controller 110 may identify a point at which the magnitude of the current has a greatest value (S1430).

The controller 110 may determine whether the magnitude of the current at the point at which the magnitude of the current has the greatest value exceeds a threshold value (S1450), and when the magnitude of the current exceeds the threshold value, may set a frequency at which the magnitude of the current has the greatest value as the frequency of the current flowing (or to flow) through the coil (S1470).

When the magnitude of the current at the point at which the magnitude of the current has the greatest value is less than the threshold value, the controller 110 may determine that the aerosol generating device is defective (S1490).

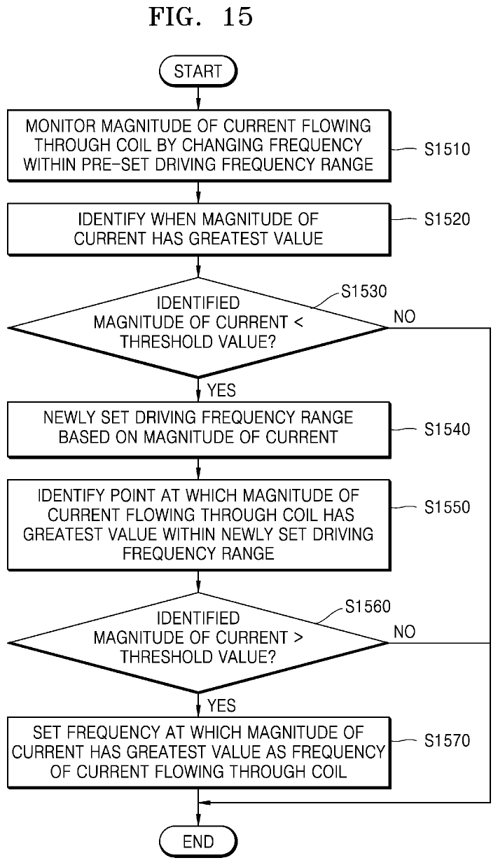

FIG. 15 is a flowchart of another example of a method of performing multicalibration on a temperature value measured by a temperature sensor, according to an embodiment of the present disclosure.

FIG. 15 may be implemented by the aerosol generating device 10 or the controller 110 previously described, and thus, descriptions will be given based on the aerosol generating device 10 or the controller 110. Hereinafter, aspects that are the same as the aspects described above will not be described.

The controller 110 may monitor a magnitude of a current flowing through a coil by changing a frequency within a pre-set driving frequency (S1510). The controller 110 may identify a point at which the magnitude of the current has a greatest value (S1520), and when the identified magnitude of the current is less than a threshold value (S1530), the controller 110 may reset the driving frequency range based on the magnitude of the current (S1540).

The controller 110 may identify a point at which the magnitude of the current flowing through the coil has a greatest value within the newly set driving frequency range (a second frequency range) (S1550).

When the identified magnitude of the current exceeds the threshold value (S1560), the controller 110 may set a frequency at which the magnitude of the current has the greatest value as the frequency of the current flowing through the coil (S1570). Schematic descriptions with respect to FIG. 15 are the same as the descriptions with respect to FIGS. 12 and 13.

The embodiments of the present disclosure described above may be realized as a form of a computer program executable on a computer via various components, and the computer program may be recorded on a computer-readable medium. Here, the medium may include a magnetic medium, such as a hard disk, a floppy disk, and a magnetic tape, an optical recording medium, such as a compact disk (CD)-read-only memory (ROM) and a digital versatile disk (DVD), a magneto-optical medium, such as a floptical disk, and a hardware device specially configured to store and execute program instructions, such as a read-only memory (ROM), a random-access memory (RAM), and a flash memory.

The computer program may be specially designed and constructed for embodiments of the present disclosure, and may be understood and usable by one of ordinary skill in a field of computer software. Examples of the computer program may include a high-level language code that may be executed by a computer using an interpreter as well as a machine language code made by a complier.

Particular executions described in the present disclosure are examples and do not limit the technical scope by any means. For the sake of brevity, conventional electronics, control systems, software development, and other functional aspects of the systems may not be described. Furthermore, the connecting lines, or connectors shown in the various figures presented are intended to represent example functional relationships and/or physical or logical couplings between the various elements. It should be noted that many alternative or additional functional relationships, physical connections, or logical connections may be present in a practical device. Also, unless particular descriptions, such as “essential,” “important,” etc., are included, components may not be components that are necessarily required for the application of embodiments of the present disclosure.

The use of the term “the” and other similar demonstrative terms in the specification (and claims) of the present disclosure may correspond to both of a singular and a plural meaning. Also, when a range is described in the present disclosure, separate values included in the range are included in the present disclosure (unless there is a description contrary thereto), and it should be understood as the same as the case in which the separate values are described in the detailed description of the present disclosure. Lastly, operations included in a method may be performed in any order, unless the operations included in the method are described to be performed only in a specific order, or unless the operations included in the method are described to be performed otherwise. Embodiments of the present disclosure is not necessarily limited to the described order of operations. All examples and example expressions (“for example,” etc.) are only used to describe the present disclosure in detail, and these examples and example expressions do not limit the scope of the present disclosure. Also, one of ordinary skill in the art would understand that various changes, combinations, and alterations may be made within the scope of the present disclosure and equivalents thereof.

### INDUSTRIAL APPLICABILITY

An embodiment of the present disclosure may be used to manufacture a next generation electronic cigarette.

1. An aerosol generating device comprising:
a coil configured to generate a magnetic field by a current flowing through the coil;
a heater configured to be induction heated via the magnetic field; and
a controller configured to control the current,
wherein the controller is further configured to:
change a frequency of the current flowing through the coil within a pre-set driving frequency range; and
determine whether a magnitude of the current flowing through the coil exceeds a threshold value according to one or more changed frequencies of the current.

2. The aerosol generating device of claim 1, wherein the controller is further configured to sequentially change the frequency of the current in a pre-set unit, from a minimum frequency within the pre-set driving frequency range.

3. The aerosol generating device of claim 1, wherein the threshold value is 4 A.

4. The aerosol generating device of claim 1, wherein the controller is further configured to:
search for an optimum frequency at which the current flowing through the coil has a magnitude that exceeds the threshold value and has a greatest value; and
based on an input with respect to a power button being sensed, control the current to flow through the coil at the optimum frequency.

5. The aerosol generating device of claim 1, wherein the controller is further configured to determine the pre-set driving frequency range based on pieces of hardware included in the aerosol generating device.

6. An aerosol generating device comprising:
a coil configured to generate a magnetic field by a current flowing through the coil;
a heater configured to be induction heated via the magnetic field; and
a controller configured to control the current,
wherein the controller is further configured to:
change a frequency of the current flowing through the coil within a pre-set first frequency range;
based on a magnitude of the current flowing through the coil being less than a threshold value, with respect to frequencies included in the pre-set first frequency range, set a second frequency range; and
determine whether the magnitude of the current flowing through the coil exceeds the threshold value, with respect to frequencies included in the second frequency range.

7. The aerosol generating device of claim 6, wherein the controller is further configured to determine the pre-set first frequency range based on pieces of hardware included in the aerosol generating device.

8. The aerosol generating device of claim 6, wherein the threshold value is 4 A.

9. The aerosol generating device of claim 6, wherein the controller is further configured to determine a minimum frequency and a maximum frequency of the second frequency range based on a ratio of the magnitude of the current of the coil to the frequency of the current flowing through the coil.

10. The aerosol generating device of claim 9, wherein the minimum frequency is included in the pre-set first frequency range.

11. The aerosol generating device of claim 10, wherein the maximum frequency is determined according to the minimum frequency.

12. The aerosol generating device of claim 9, wherein the maximum frequency is included in the pre-set first frequency range.

13. The aerosol generating device of claim 12, wherein the minimum frequency is determined according to the maximum frequency.

14. A method of optimizing a frequency of a current flowing through a coil of an aerosol generating device, the method comprising:
monitoring a magnitude of the current flowing through the coil, by changing the frequency within a pre-set driving frequency range;
identifying a frequency, within the pre-set driving frequency range, at which the magnitude of the current of the coil has a greatest value; and
determining whether the magnitude of the current at the identified frequency exceeds a threshold value.

15. The method of claim 14, wherein the monitoring of the magnitude of the current comprises changing the frequency within the pre-set driving frequency range according to a pre-set unit frequency.

16. The method of claim 14, further comprising, based on an input with respect to a power button being sensed, controlling the current to flow through the coil at the identified frequency.

17. The method of claim 14, wherein the pre-set driving frequency range is set based on pieces of hardware included in the aerosol generating device.

18. A method of optimizing a frequency of a current flowing through a coil of an aerosol generating device, the method comprising:
monitoring a magnitude of the current flowing through the coil, by changing the frequency within a pre-set first frequency range;
identifying a first frequency, within the pre-set first frequency range, at which the magnitude of the current of the coil has a greatest value;
based on the magnitude of the current at the identified first frequency being less than a threshold value, setting a second frequency range;
identifying a second frequency at which the magnitude of the current flowing through the coil has a greatest value, by changing the frequency within the second frequency range; and
based on the magnitude of the current at the second frequency exceeding the threshold value, setting the second frequency as an optimum frequency of the current of the coil.

19. The method of claim 18, wherein a minimum frequency and a maximum frequency of the second frequency range are determined based on a ratio of the magnitude of the current of the coil to the frequency of the current flowing through the coil.

20. A computer-readable recording medium having stored thereon a program for executing the method according to claim 14.
